(19) United States
(12) Patent Application Publication
(10) Pub. No.: US 2025/0142522 A1
(43) Pub. Date: May 1, 2025

(54) BACKSCATTERING AND UE FINDER-BASED POSITIONING FOR A-IOT

(71) Applicant: Mediatek Inc., Hsinchu (TW)

(72) Inventors: Chien-Chun CHENG, Hsinchu (TW); Chiao-Yao Chuang, Hsinchu (TW); Wei-De Wu, Hsichu (TW); Chiou-Wei Tsai, Hsinchu (TW); Tai-Cheng Tsai, Hsinchu (TW)

(21) Appl. No.: 18/919,716

(22) Filed: Oct. 18, 2024

Related U.S. Application Data
(60) Provisional application No. 63/593,548, filed on Oct. 27, 2023.

(51) Int. Cl. H04W 64/00; H04B 17/318; H04L 43/0864; H04W 24/10

(52) U.S. Cl. CPC H04W 64/00; H04B 17/318; H04L 43/0864; H04W 24/10

(57) ABSTRACT

In an aspect of the disclosure, a method, a computer-readable medium, and an apparatus are provided. The apparatus may be a reader. The reader receives a response signal set that responds to a radio signal, from an ambient internet of things (A-IoT) device set, a response signal in the response signal set being modulated by a corresponding A-IoT device in the A-IoT device set to include an identification of the corresponding A-IoT device. The reader identifies the corresponding A-IoT device based on the identification of the corresponding A-IoT device, and performs measurement for a positioning parameter. The reader executes a positioning related operation based on the identified A-IoT device and the measurement for the positioning parameter.

### CROSS-REFERENCE TO RELATED APPLICATION(S)

This application claims the benefits of U.S. Provisional Application Ser. No. 63/593,548, entitled “BACKSCATTERING AND UE FINDER-BASED POSITIONING FOR A-IoT” and filed on Oct. 27, 2023, which is expressly incorporated by reference herein in its entirety.

### BACKGROUND

### Field

The present disclosure relates generally to wireless communications, and more particularly, to using passive IoT devices for positioning with respect to user equipment (UE) and network apparatus in mobile communications.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a reader. The reader receives a response signal set that responds to a radio signal, from an ambient internet of things (A-IoT) device set, a response signal in the response signal set being modulated by a corresponding A-IoT device in the A-IoT device set to include an identification of the corresponding A-IoT device. The reader identifies the corresponding A-IoT device based on the identification of the corresponding A-IoT device, and performs measurement for a positioning parameter. The reader executes a positioning related operation based on the identified A-IoT device and the measurement for the positioning parameter.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7(A) is a diagram illustrating an example wireless communication system including a base station and a UE.

FIG. 7(B) is a diagram illustrating an example architecture regarding approximate positioning by using an A-IoT device.

FIG. 8 is a sequence diagram regarding approximate positioning.

FIG. 9 is a sequence diagram that reflects the changes in the process where the A-IoT device broadcasts a signal with its public key, the finder UE estimates the A-IoT device's location using SL-RTT, and the potential use of sidelink for communication is considered.

FIG. 10 is a diagram illustrating the behavior of the UE and gNB, and the signaling between them in the scenario where a UE acts as a security gateway for an A-IoT device.

FIG. 11 is a diagram illustrating the behavior of the A-IoT device, UE, and gNB, and the signaling between them in the scenario where a UE acts as a relay for an A-IoT device.

FIG. 12 is a sequence diagram illustrating the interaction between the UE, the gNB, and the A-IoT device regarding the public key usage.

FIG. 13 is a sequence diagram representing a behavior of the UE and the gNB.

FIG. 14 is a sequence diagram that represents another behavior of the UE and the gNB.

FIG. 15 is a sequence diagram representing a further behavior of the UE and the gNB.

FIG. 16 is a sequence diagram that includes two different gNBs-one for the finder UE and another for the owner UE.

FIG. 17 illustrates an example communication system having an example communication apparatus and an example network apparatus.

FIG. 18(A) is a diagram illustrating an example architecture regarding precise positioning by using multiple A-IoT devices.

FIG. 18(B) is a sequence diagram for the UE behavior, gNB behavior, and the signaling.

FIG. 19(A) is a diagram illustrating an example scheme utilized by a gNB for estimating the location of a passive A-IoT device with the assistance of multiple UE finders.

FIG. 19(B) is a sequence diagram for the UE finder behavior, gNB behavior, and the signaling.

FIG. 20(A) is a flow chart of a process for positioning regarding the UE and the A-IoT device.

FIG. 20(B) is a flow chart of another process for positioning regarding the UE and the A-IoT device.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

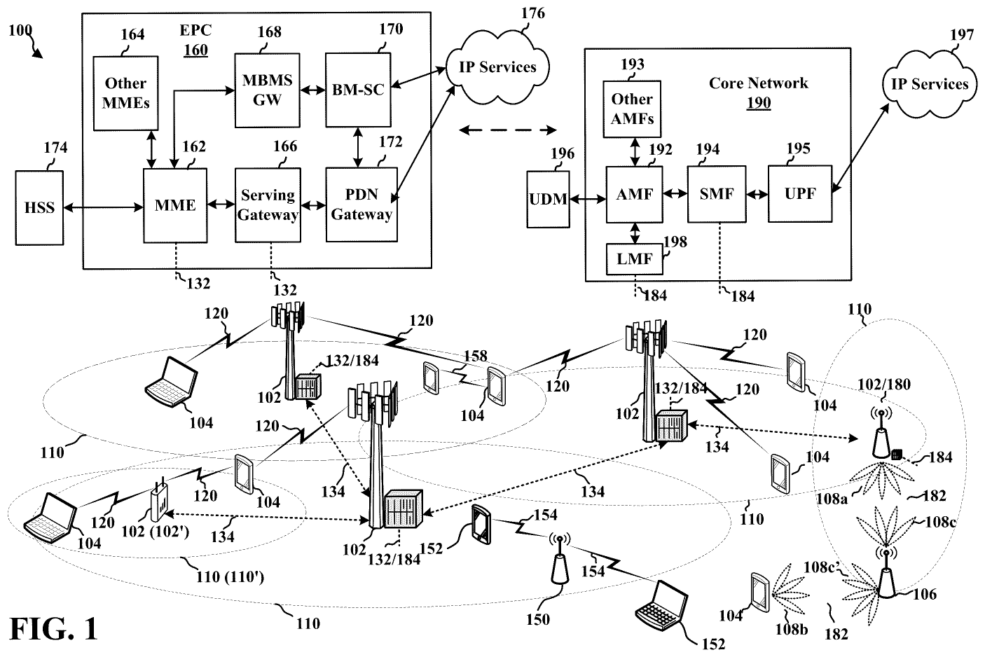

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

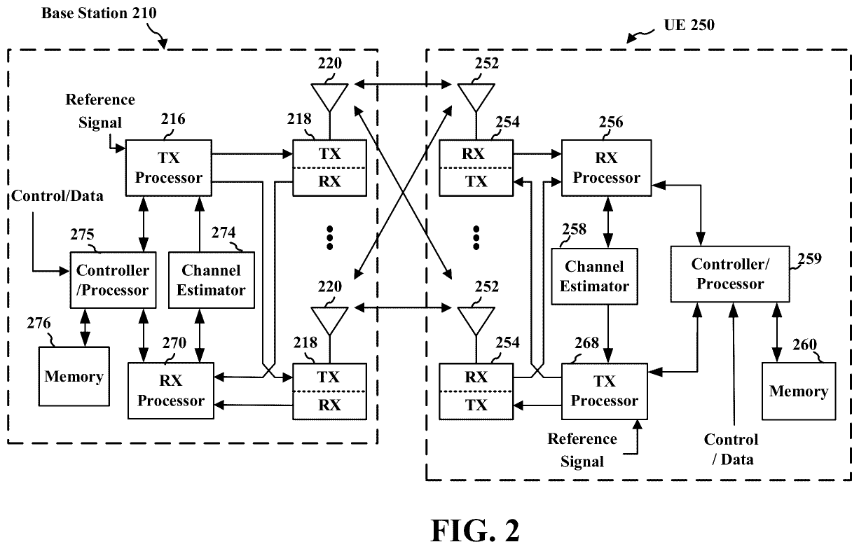

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate mapping matching, onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

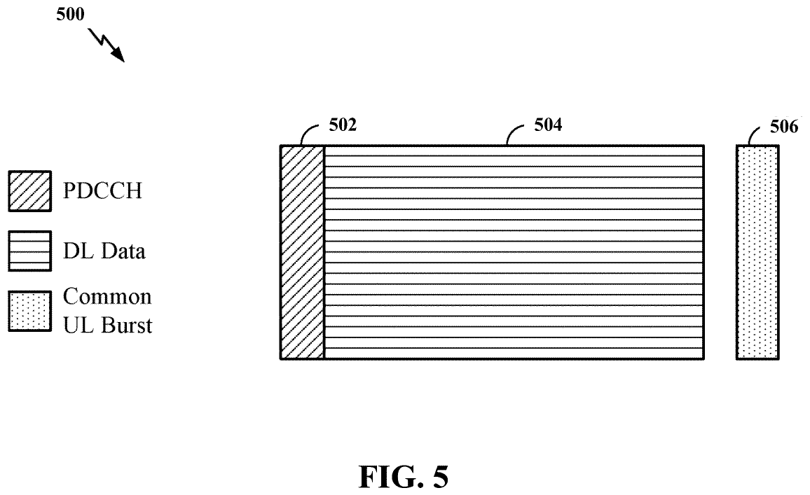

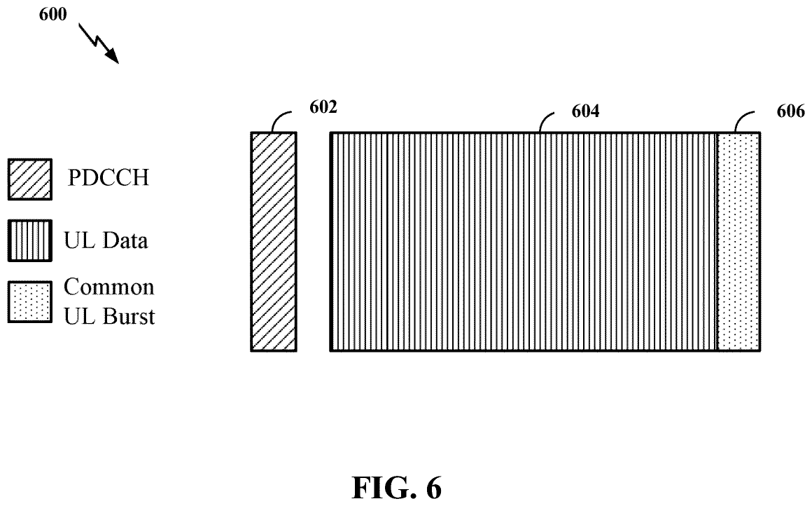

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

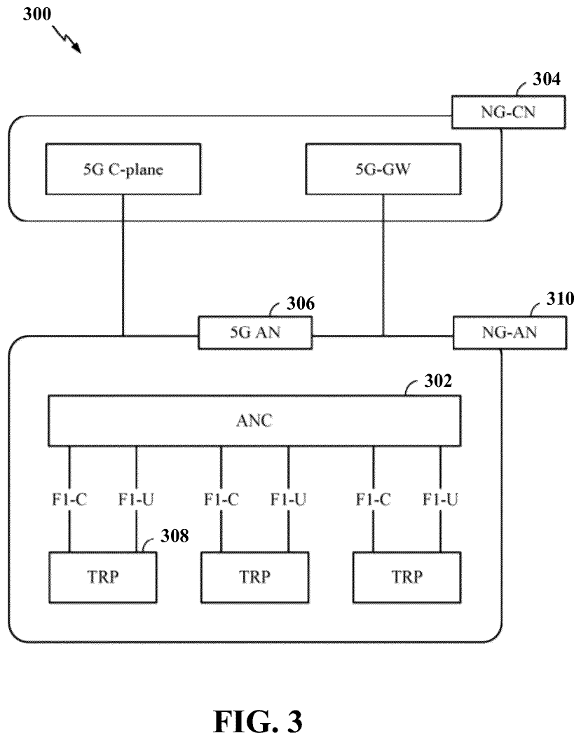

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

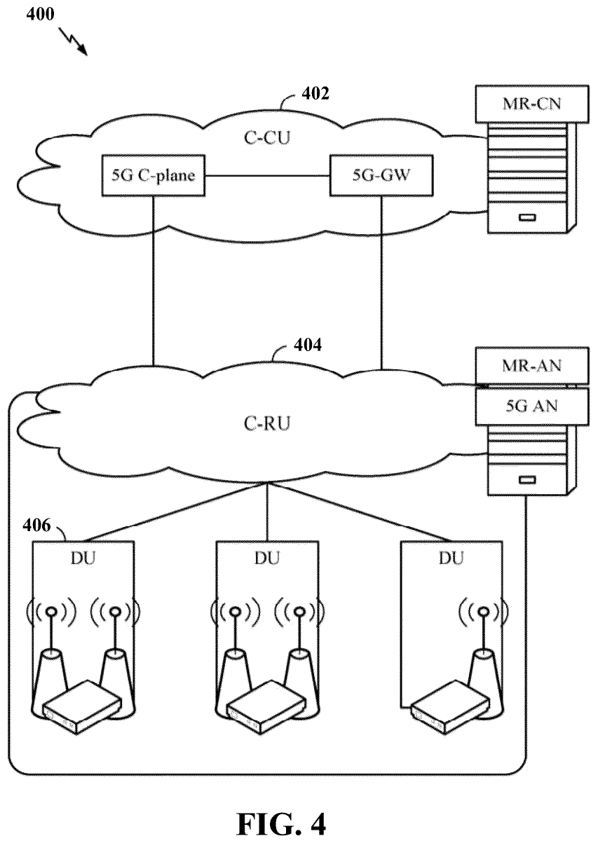

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

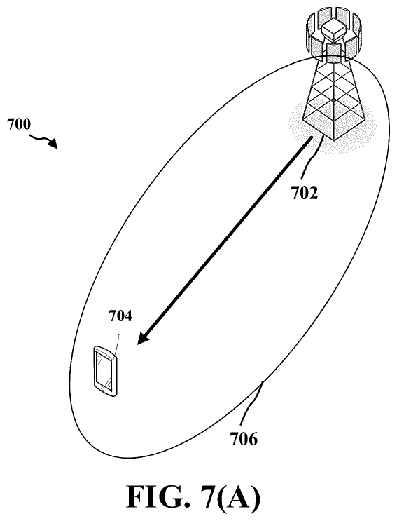

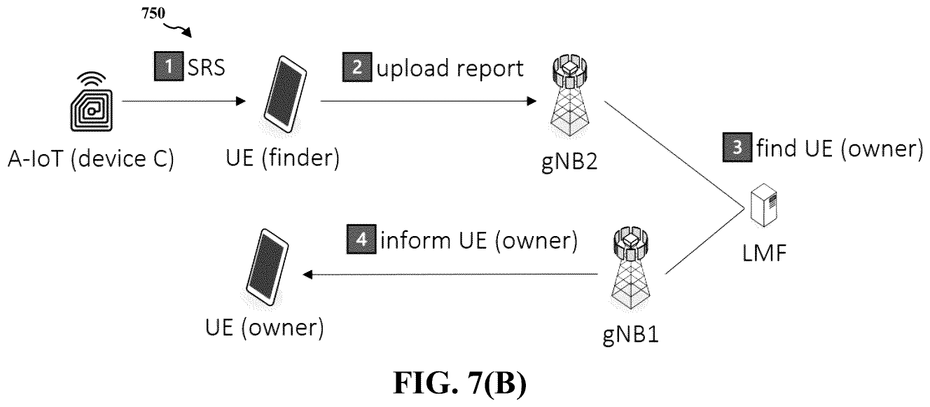

FIG. 7(A) is a diagram 700 illustrating an example wireless communication system including a base station and a UE. In this example, a UE 704 is connected to a base station 702 on a cell 706.

The surge in Internet of Things (IoT) devices necessitates efficient tracking. Current battery-powered and energy-harvesting solutions are unfeasible, prompting a need for a new, low-power, high-efficiency positioning technology for Ambient Internet of Things (A-IoT) devices.

The disclosure focusses on a User Equipment (UE) that uses signals from A-IoT devices to estimate its own location or that of an A-IoT device. It does this by receiving and analyzing signals, determining key parameters, and performing position calculations. The process leverages existing mechanisms and the accuracy depends on several factors such as the number of A-IoT devices and signal quality.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### Approximate Positioning

FIG. 7(B) is a diagram 750 illustrating an example architecture regarding approximate positioning by using an A-IoT device. The A-IoT device pairs with the owner UE and registers with the gNB through a secure tunnel. The device then broadcasts its public key for discovery by other UEs, known as finder UEs. The finder UEs can estimate the A-IoT device's location using signal-based methods and report it to the gNB. The gNB forwards this information to the Location Management Function (LMF) in the network, which decides whether to inform the owner UE about the new location of the A-IoT device. If the decision is made to inform the owner, the gNB packages the location information as user data, encrypts it with the owner UE's key, and sends it to the owner UE. The owner UE decrypts the data and displays the updated location of the A-IoT device.

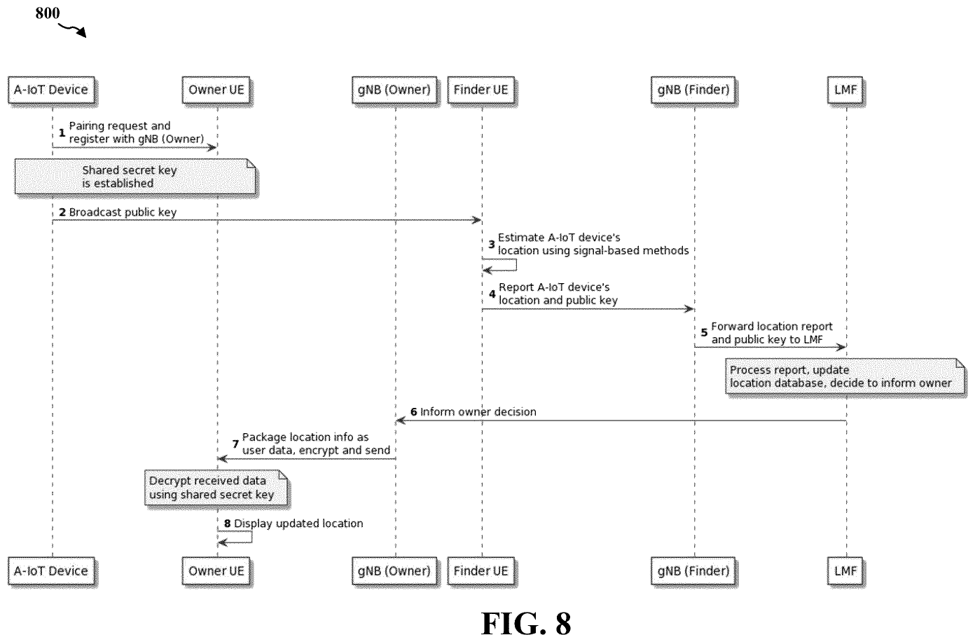

FIG. 8 is a sequence diagram 800 regarding approximate positioning. In some embodiment, the A-IoT device, which can be considered as a UE, pairs with the owner UE and registers with the gNB through a secure tunnel. The device then broadcasts a signal, which includes its public key, for discovery by other UEs, known as finder UEs. These finder UEs can estimate the A-IoT device's location using signal-based methods such as SideLink Round Trip Time (SL-RTT), which requires both the A-IoT device and the finder UE to send a SideLink Positioning Reference Signal (SL-PRS) to each other.

The finder UEs then report this location information to their respective gNBs. The gNBs forward this information to the Location Management Function (LMF) in the network, which decides whether to inform the owner UE about the new location of the A-IoT device. If the decision is made to inform the owner, the gNB packages the location information as user data, encrypts it with the owner UE's key, and sends it to the owner UE. The owner UE decrypts the data and displays the updated location of the A-IoT device.

This process could further consider using sidelink for communication involving the network for scheduling resources between UEs' transmissions. Two sequence diagrams are proposed: one for communication between UEs using sidelink, and another for point-to-point transmission for estimating the A-IoT device location.

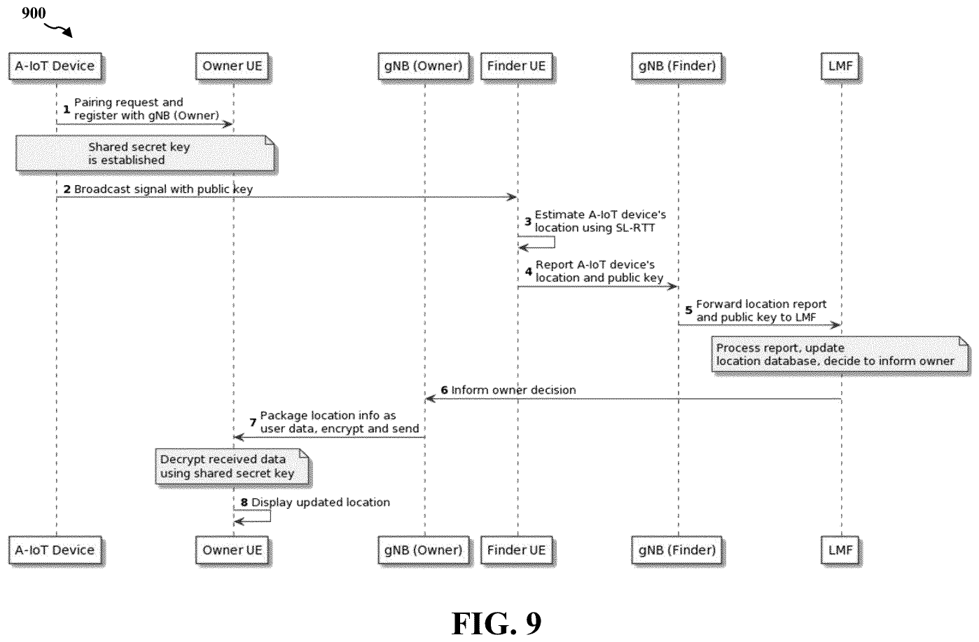

FIG. 9 is a sequence diagram 900 that reflects the changes in the process where the A-IoT device broadcasts a signal with its public key, the finder UE estimates the A-IoT device's location using SL-RTT, and the potential use of sidelink for communication is considered.

### Initial Paring and Public Key

The A-IoT device is indirectly connected to the gNB via a UE, which is its owner. The A-IoT device doesn't directly interact with the gNB. Here's a simplified approach:

Device Pairing: The A-IoT device is first paired with the UE. This can be done using a standard pairing procedure, such as WIFI paring, Bluetooth pairing or NR sidelink pairing, during which a shared secret key is established.

Secure Tunnel Establishment: The UE, which has a direct connection to the gNB, establishes a secure tunnel for the A-IoT device. This could be done using existing NR security procedures. The UE acts as a security gateway for the A-IoT device.

Data Transmission: When the A-IoT device has data to send, it first encrypts the data using the shared secret key and sends it to the UE. The UE then sends this data over the secure tunnel to the gNB. For incoming data, the process is reversed.

Key Refresh and Rekeying: The UE can perform key refresh and rekeying operations on behalf of the A-IoT device. This can be done using the existing NR procedures.

The UE acts as a security gateway for the A-IoT device, handling all interactions with the gNB. This ensures the security of the A-IoT device's data while minimizing the changes needed to existing procedures.

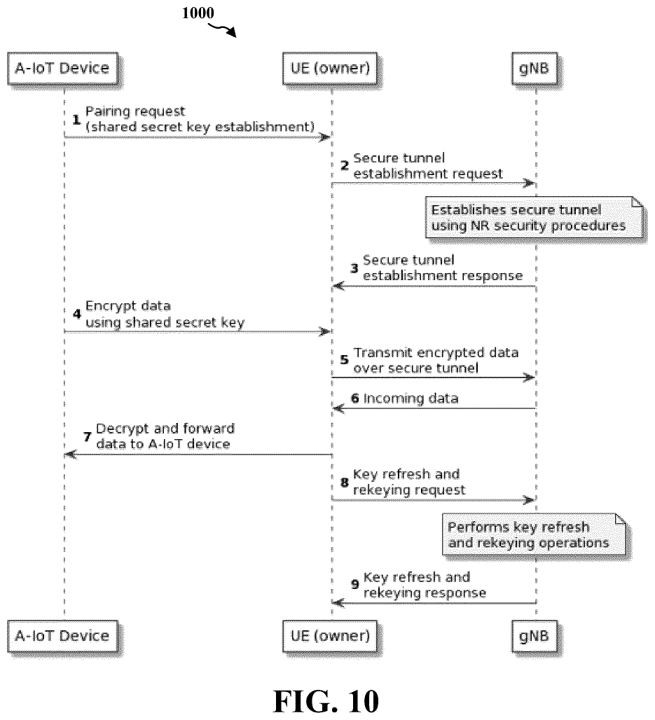

FIG. 10 is a diagram 1000 illustrating the behavior of the UE and gNB, and the signaling between them in the scenario where a UE acts as a security gateway for an A-IoT device. The UE pairs with the A-IoT device, establishes a secure tunnel with the gNB, and handles the encryption, transmission, and decryption of data. The UE also requests key refresh and rekeying operations from the gNB as needed.

Device pairing is achieved through a series of procedures that ensure secure communication. Here's a simplified version of the process:

Discovery: The A-IoT and the UE perform a discovery procedure, and establish a PC5-RRC connection using the NR sidelink PC5 unicast link establishment procedure.

Initial Connection: The A-IoT sends the first RRC message (i.e., RRCSetupRequest) for its connection establishment with gNB via the UE, using a specified PC5 Relay RLC channel configuration.

Relaying Channel Setup: The gNB and the UE perform a relaying channel setup procedure over Uu. According to the configuration from gNB, the UE establishes a PC5 Relay RLC channel for relaying of SRB1 towards the A-IoT over PC5.

RRC Connection Establishment: The RRCSetupComplete message is sent by the A-IoT to the gNB via the UE using SRB1 relaying channel over PC5 and SRB1 relaying channel configured to the UE over Uu. Then the A-IoT is as in RRC_CONNECTED with the gNB.

Security Establishment: The A-IoT and gNB establish security following the Uu security mode procedure and the security messages are forwarded through the UE.

This process ensures that the A-IoT and the UE are securely paired and can communicate with each other.

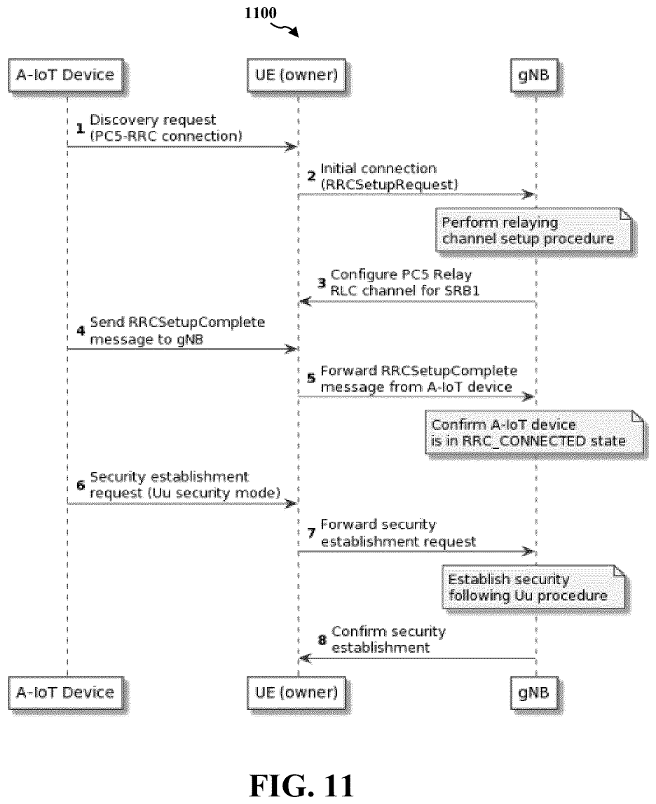

FIG. 11 is a diagram 1100 illustrating the behavior of the A-IoT device, UE, and gNB, and the signaling between them in the scenario where a UE acts as a relay for an A-IoT device. The A-IoT device initiates a discovery request, and the UE forwards this to the gNB. The gNB and UE then set up a relaying channel. The A-IoT device sends an RRCSetupComplete message to the gNB via the UE, and then requests security establishment. The UE forwards this request, and the gNB confirms the establishment of security.

After pairing and security establishment, if the A-IoT device needs to broadcast a public key to be discoverable by other UEs (not owner UE), it can use a specifically generated Public Key for this purpose.

This Public Key is separate from the keys used for secure communication with the owner UE and the gNB. The Public Key can be used by other UEs to encrypt data sent to the A-IoT device, but it does not compromise the security of the A-IoT device because it cannot be used to decrypt any data.

The A-IoT device can periodically change this Public Key to further enhance security (a method known as key rotation). This way, even if a malicious party gets hold of the Public Key, they can only use it for a limited time before it becomes obsolete.

Therefore, the A-IoT device can broadcast this Public Key without losing security, allowing other UEs to discover and securely communicate with it.

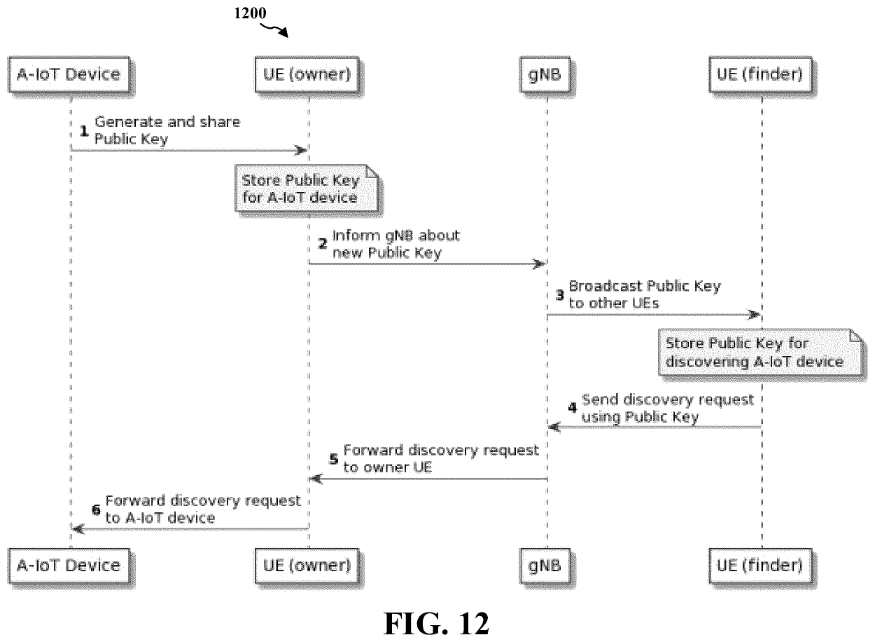

FIG. 12 is a sequence diagram 1200 illustrating the interaction between the UE, the gNB, and the A-IoT device regarding the public key usage.

In this sequence, the A-IoT device first generates a public key and shares it with its owner UE. The owner UE then informs the gNB about the new public key. Subsequently, the gNB broadcasts the public key to other UEs, which we refer to as finders. These finder UEs can now use the broadcasted public key to send a discovery request to the gNB. Upon receiving the request, the gNB forwards it to the owner UE, which in turn forwards the discovery request to the A-IoT device. This process ensures that other UEs can discover the A-IoT device using the broadcasted public key.

### Broadcasting Public Key

The A-IoT device is capable of broadcasting its public key, which can be utilized by UEs for its discovery. This public key can be broadcasted at regular intervals or in response to a specific event or trigger.

Discovery by Finder UE: A finder UE can use this broadcasted public key to identify the A-IoT device. It can send a discovery request to the gNB using this public key. For example, the A-IoT device sends a discovery signal every 2 seconds, embedding the public key within the content of the signal. The discovery signal can reuse NR Sounding Reference Signal (SRS) or Random Access Preamble sequences. Once the A-IoT is discovered, the finder UE can then use standard pairing procedures, such as WIFI pairing, Bluetooth pairing, or NR sidelink pairing, to establish a shared secret key with the A-IoT device.

Pairing with Finder UE: Once the A-IoT device is discovered, it can pair with the finder UE using a secure pairing procedure. This procedure could involve the exchange of additional keys or credentials, facilitated by the gNB or the owner UE. This secure pairing can also be achieved using standard pairing procedures such as WIFI pairing, Bluetooth pairing, or NR sidelink pairing, during which a shared secret key is established.

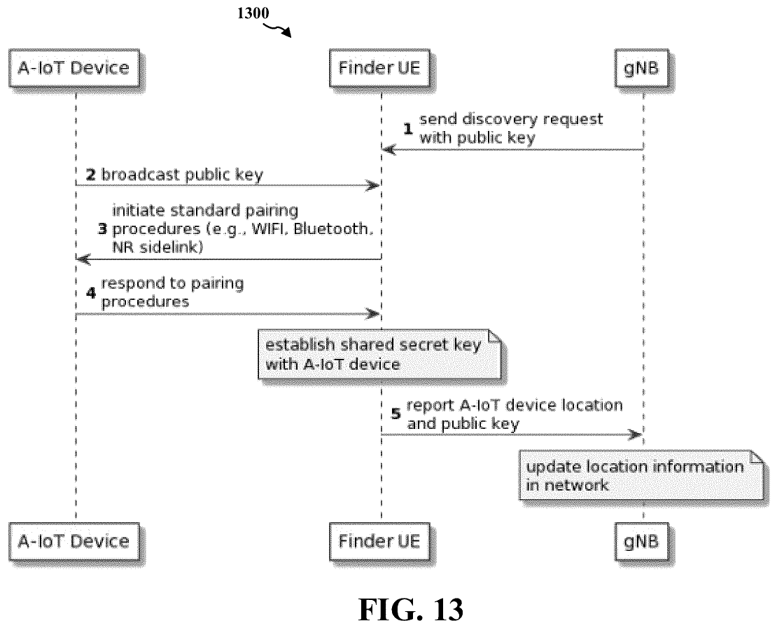

FIG. 13 is a sequence diagram 1300 representing the behavior of the UE and the gNB. In this sequence diagram, the A-IoT device broadcasts its public key, which is picked up by the finder UE. The finder UE initiates standard pairing procedures with the A-IoT device. Once the pairing is successful and a shared secret key is established, the finder UE reports the A-IoT device's location and public key back to the gNB, which then updates the location information in the network.

### Finder UE Reporting

Upon successful pairing with the A-IoT device, the finder UE is able to estimate the A-IoT device's location and report it to the gNB. The finder UE, knowing its own position (via GPS or network-based positioning), estimates the A-IoT device's location using signal-based methods such as Signal Strength (RSSI) and Round-Trip Time (RTT).

The RSSI method involves measuring the signal strength from the A-IoT device, with the understanding that signal strength decreases with distance. The RTT method involves sending a signal to the A-IoT device and measuring the time it takes for the signal to return, which can be used to calculate the distance to the A-IoT device.

Once the distance to the A-IoT device is estimated, the finder UE uses its own position to determine the A-IoT device's location. If multiple finder UEs are involved, triangulation can be used for more accurate location estimation.

To transmit this location information and the public key to the gNB, the finder UE uses UL channels such as the Physical Uplink Shared Channel (PUSCH), the Physical Uplink Control Channel (PUCCH), or the Random Access Channel (RACH) as per standard NR location reporting procedures. This ensures the gNB is updated with the A-IoT device's location.

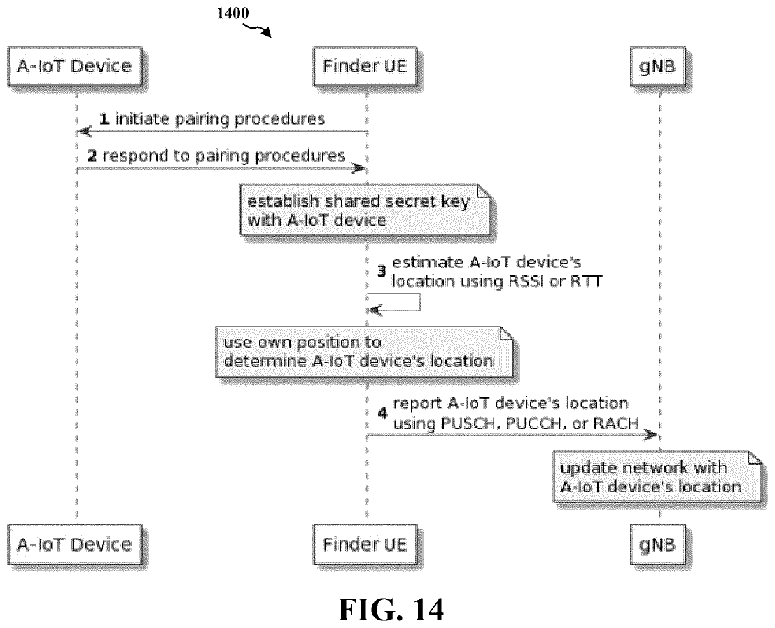

FIG. 14 is a sequence diagram 1400 that represents the behavior of the UE and the gNB. In this sequence diagram, the finder UE initiates pairing procedures with the A-IoT device. After the A-IoT device responds to the pairing procedures, a shared secret key is established. The finder UE then estimates the A-IoT device's location using methods like RSSI or RTT, and uses its own position to determine the A-IoT device's location. This location information is then reported to the gNB using channels like PUSCH, PUCCH, or RACH. Finally, the gNB updates the network with the A-IoT device's location.

In some embodiments, after forming a successful pairing with the A-IoT device, the finder UE, even without knowledge of its own absolute position, can estimate the relative distance to the A-IoT device. This estimation is done using signal-based methods such as Signal Strength (RSSI) and Round-Trip Time (RTT).

The RSSI method involves measuring the signal strength from the A-IoT device, based on the principle that signal strength decreases with increased distance. The RTT method involves sending a signal to the A-IoT device and measuring the time it takes for the signal to return, thereby calculating the relative distance to the A-IoT device.

This relative location information, along with the public key of the A-IoT device, is then processed by a computation entity. This computation entity could be the LMF, the finder UE itself, or another UE. Notably, this computation entity can leverage the sidelink positioning structure for processing the measurements, providing a more efficient and accurate estimation of the A-IoT device's location.

Upon processing, the finder UE transmits this information to the gNB using UL channels such as the Physical Uplink Shared Channel (PUSCH), the Physical Uplink Control Channel (PUCCH), or the Random Access Channel (RACH). This aligns with standard NR location reporting procedures, ensuring that the gNB is updated with the A-IoT device's relative location information.

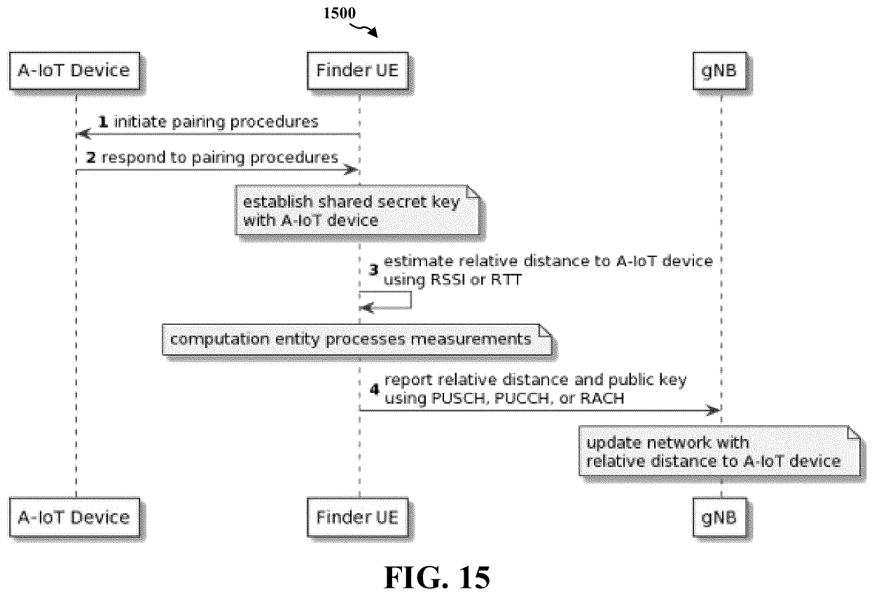

FIG. 15 is a sequence diagram 1500 representing the behavior of the UE and the gNB. In this sequence diagram, the finder UE initiates pairing procedures with the A-IoT device. After the A-IoT device responds to the pairing procedures, a shared secret key is established. The finder UE then estimates the relative distance to the A-IoT device using methods like RSSI or RTT, and a computation entity processes these measurements. This relative distance information, along with the public key, is then reported to the gNB. Finally, the gNB updates the network with the relative distance to the A-IoT device.

### LMF Querying

When the gNB receives the location report from a finder UE along with the reported public key of the A-IoT device, it can forward this information to the Location Management Function (LMF) in the network. Here's how this can happen:

gNB to LMF: The gNB can use a standard interface (like the X2 interface in LTE or the N2 interface in 5G NR) to send a location report to the LMF. The report can include the public key of the A-IoT device, the identity of the finder UE, and the estimated location of the A-IoT device.

LMF Processing: The LMF can process this report, update its location database, and decide whether to inform the owner UE about the new location of the A-IoT device. The decision can be based on various factors, such as the accuracy of the new location, the time since the last update, and the preferences of the owner.

LMF to gNB: If the LMF decides to inform the owner, it can send a message to the gNB serving the owner UE. This message can include the public key of the A-IoT device and its new location.

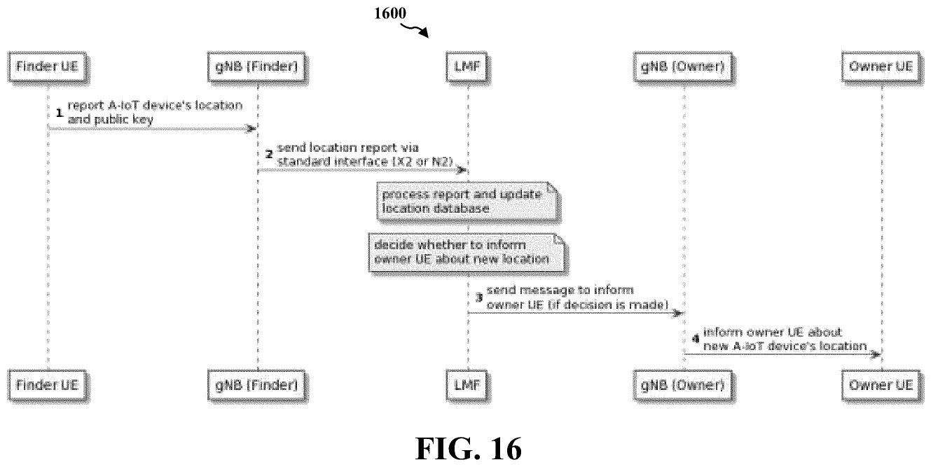

FIG. 16 is a sequence diagram 1600 that includes two different gNBs-one for the finder UE and another for the owner UE. In this sequence diagram, the finder UE reports the A-IoT device's location and public key to its gNB (gNB for Finder). The gNB then sends this location report to the LMF using a standard interface (like X2 or N2). The LMF processes the report, updates its location database, and decides whether to inform the owner UE about the new location of the A-IoT device. If the decision is made to inform the owner, the LMF sends a message to the gNB serving the owner UE (gNB for Owner), which then informs the owner UE about the new location of the A-IoT device.

### Informing Owner UE

Once the gNB receives the updated location of the A-IoT device, it can securely package this information as user data to relay to the owner UE. The gNB can use standard NR procedures for data transfer to send this information. For instance, it can use the PDSCH, which is primarily used for transmitting user data in NR.

To ensure the privacy and integrity of the location information, the data is encrypted using the owner UE's key. This encryption can be achieved using NR security procedures, like the application of NAS (Non-Access Stratum) security or AS (Access Stratum) security.

Upon receiving the data, the owner device decrypts the location reports using its key. This decryption can be performed using the NR security procedures in reverse. Once decrypted, the owner UE can then display the updated approximate location of the paired A-IoT device.

In the disclosure, a user equipment (UE) is provided, including: one or more non-transitory computer-readable media having computer-executable instructions embodied thereon, and at least one processor coupled to the one or more non-transitory computer-readable media and configured to execute the computer-executable instructions to: receive from a base station (BS), a request for a public key of an A-IoT device, if the UE is paired with the A-IoT device and registered with the BS through a secure tunnel; determine the location of the A-IoT device using signal-based methods, if the UE is a finder UE and has established a shared secret key with the A-IoT device; perform decryption of the location reports using its key, if the UE is the owner of the A-IoT device and has received encrypted location data from the BS; and transmit, to the BS, the determined location of the A-IoT device along with the public key of the A-IoT device, if the UE is a finder UE and has estimated the location of the A-IoT device.

In the disclosure, a user equipment (UE) is provided, including: one or more non-transitory computer-readable media having computer-executable instructions embodied thereon, and at least one processor coupled to the one or more non-transitory computer-readable media and configured to execute the computer-executable instructions to: receive from a base station (BS), a secure tunnel for an A-IoT device, if the UE is the owner of the A-IoT device and is directly connected to the BS; determine the public key of the A-IoT device, if the A-IoT device is paired with the UE and has broadcasted its public key for discovery; perform key refresh and rekeying operations on behalf of the A-IoT device, if the A-IoT device and the UE have established a shared secret key; and transmit, to the BS, data from the A-IoT device over the secure tunnel, if the A-IoT device has data to send and has encrypted the data using the shared secret key.

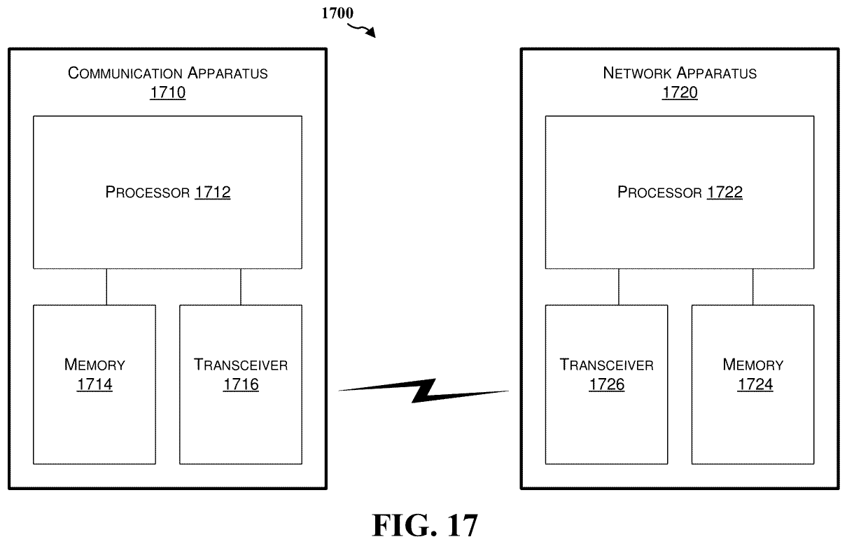

FIG. 17 illustrates an example communication system 1700 having an example communication apparatus 1710 and an example network apparatus 1720 in accordance with an implementation of the present disclosure. Each of communication apparatus 1710 and network apparatus 1720 may perform various functions to implement schemes, techniques, processes and methods described herein pertaining to using on-demand reference signal for network energy saving with respect to user equipment and network apparatus in mobile communications, including scenarios/schemes described above.

Communication apparatus 1710 may be a part of an electronic apparatus, which may be a UE such as a portable or mobile apparatus, a wearable apparatus, a wireless communication apparatus or a computing apparatus. For instance, communication apparatus 1710 may be implemented in a smartphone, a smartwatch, a personal digital assistant, a digital camera, or a computing equipment such as a tablet computer, a laptop computer or a notebook computer. Communication apparatus 1710 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 1710 may be implemented in a smart thermostat, a smart fridge, a smart door lock, a wireless speaker or a home control center. Alternatively, communication apparatus 1710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1710 may include at least some of those components shown in FIG. 17 such as a processor 1712, for example. Communication apparatus 1710 may further include one or more other components not pertinent to the proposed scheme of the present disclosure (e.g., internal power supply, display device and/or user interface device), and, thus, such component(s) of communication apparatus 1710 are neither shown in FIG. 17 nor described below in the interest of simplicity and brevity.

Network apparatus 1720 may be a part of a network apparatus, which may be a network node such as a satellite, a base station, a small cell, a router or a gateway. For instance, network apparatus 1720 may be implemented in an eNodeB in an LTE network, in a gNB in a 5G/NR, IoT, NB-IoT or IIOT network or in a satellite or base station in a 6G network. Alternatively, network apparatus 1720 may be implemented in the form of one or more IC chips such as, for example and without limitation, one or more single-core processors, one or more multi-core processors, or one or more RISC or CISC processors. Network apparatus 1720 may include at least some of those components shown in FIG. 17 such as a processor 1722, for example. Network apparatus 1720 may further include one or more other components not pertinent to the proposed scheme of the present disclosure (e.g., internal power supply, display device and/or user interface device), and, thus, such component(s) of network apparatus 1720 are neither shown in FIG. 17 nor described below in the interest of simplicity and brevity.

In one aspect, each of processor 1712 and processor 1722 may be implemented in the form of one or more single-core processors, one or more multi-core processors, or one or more CISC processors. That is, even though a singular term “a processor” is used herein to refer to processor 1712 and processor 1722, each of processor 1712 and processor 1722 may include multiple processors in some implementations and a single processor in other implementations in accordance with the present disclosure. In another aspect, each of processor 1712 and processor 1722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1712 and processor 1722 is a special-purpose machine specifically designed, arranged and configured to perform specific tasks including autonomous reliability enhancements in a device (e.g., as represented by communication apparatus 1710) and a network (e.g., as represented by network apparatus 1720) in accordance with various implementations of the present disclosure.

In some implementations, communication apparatus 1710 may also include a transceiver 1716 coupled to processor 1712 and capable of wirelessly transmitting and receiving data. In some implementations, communication apparatus 1710 may further include a memory 1714 coupled to processor 1712 and capable of being accessed by processor 1712 and storing data therein. In some implementations, network apparatus 1720 may also include a transceiver 1726 coupled to processor 1722 and capable of wirelessly transmitting and receiving data. In some implementations, network apparatus 1720 may further include a memory 1724 coupled to processor 1722 and capable of being accessed by processor 1722 and storing data therein. Accordingly, communication apparatus 1710 and network apparatus 1720 may wirelessly communicate with each other via transceiver 1716 and transceiver 1726, respectively. To aid better understanding, the following description of the operations, functionalities and capabilities of each of communication apparatus 1710 and network apparatus 1720 is provided in the context of a mobile communication environment in which communication apparatus 1710 is implemented in or as a communication apparatus or a UE and network apparatus 1720 is implemented in or as a network node of a communication network.

### Precise Positioning

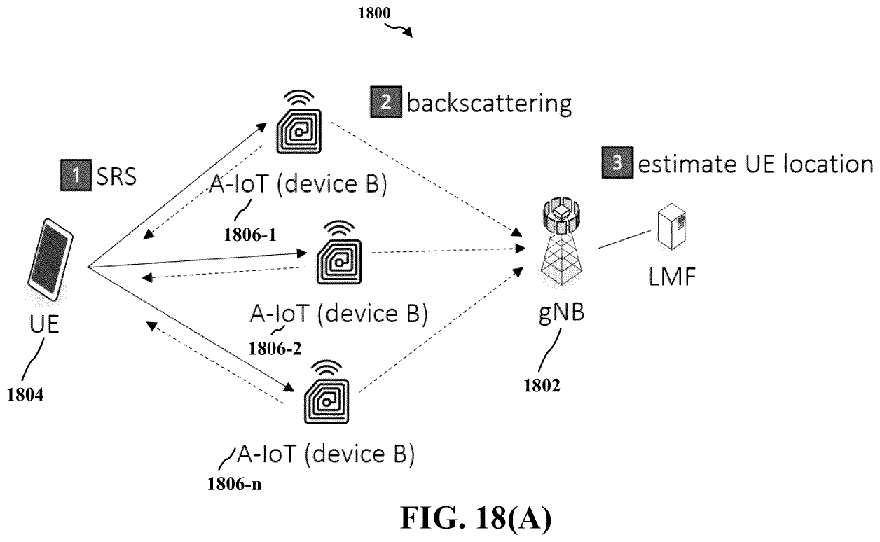

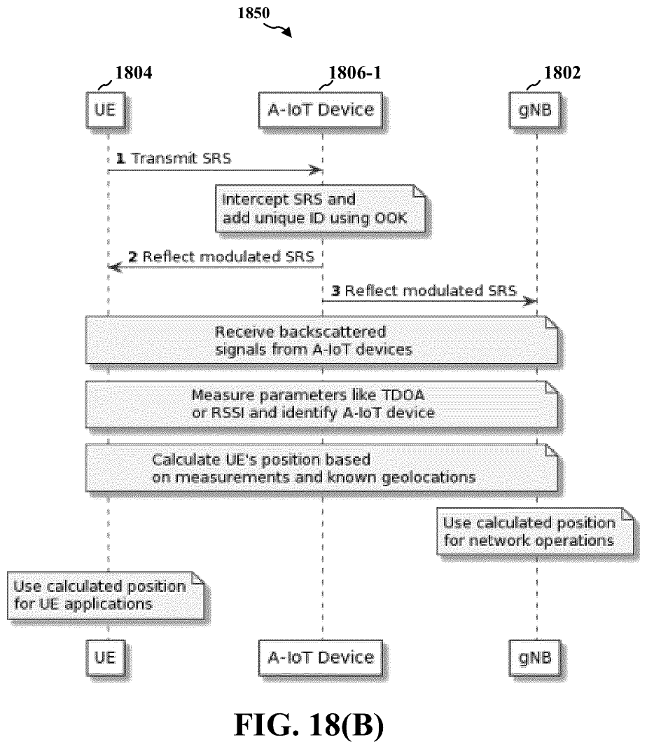

FIG. 18(A) is a diagram 1800 illustrating an example architecture regarding precise positioning by using multiple A-IoT devices. As shown in FIG. 18, if the UE 1804 and the gNB 1802 know the geolocation of an A-IoT device set including multiple A-IoT devices 1806-1, 1806-2 . . . , 1806-n, and can receive the response signals from them, such as backscattered signals, both the UE 1804 and the gNB 1802 may estimate the UE's location using the A-IoT devices 1806-1, 1806-2 . . . , 1806-n. Each A-IoT device may be passive. In this disclosure, the A-IoT device may be called “a device”, while the UE or gNB may be called “a reader”. Therefore, a communication from the A-IoT device to the reader may be called a device-to-reader (D2R) transmission, while a communication from the reader to the A-IoT device may be called a reader-to-device (R2D) transmission.

Backscattering from UE's SRS: The UE 1804 may broadcast the radio signal. For example, the UE 1804 may transmit a Sounding Reference Signal (SRS). Passive A-IoT devices 1806-1, 1806-2 . . . , 1806-n, associated with the gNB 1802, may intercept this signal. Each A-IoT device may modulate the received SRS by adding its unique identification (ID) and then reflect it back towards the gNB 1802 and the UE 1804.

For example, if the UE 1804 transmits an SRS, multiple A-IoT devices 1806-1, 1806-2 . . . , 1806-n intercept this signal. Each A-IoT device may add its unique ID to the signal and reflect it back. The reflected signal now may carry information about the original SRS and the unique ID of the A-IoT device.

In some embodiments, the UE 1804 may also transmit a general radio signal. Passive A-IoT devices 1806-1, 1806-2 . . . , 1806-n, associated with the gNB 1802, may intercept this signal. Each A-IoT device may modulate the received signal by adding its unique ID and then reflect it back towards the gNB 1802 and the UE 1804. The network may configure the UE 1804 to recognize the waveform of each A-IoT device, enabling the UE 1804 to receive it.

Signal Measurement at gNB and UE: Both the gNB 1802 and the UE 1804 may receive the backscattered signals from multiple A-IoT devices 1806-1, 1806-2 . . . , 1806-n. They may perform measurement for a positioning parameter. For example, the UE 1804 may measure positioning parameters like Time Difference of Arrival (TDOA) or Received Signal Strength Indicator (RSSI) from these signals and identify the originating A-IoT device using the unique ID embedded in the signal.

For instance, both the gNB 1802 and the UE 1804 may measure the time it takes for the backscattered signal to reach them from each A-IoT device (TDOA) or the strength of the received signal (RSSI). Additionally, they can extract the unique ID from the signal to identify the A-IoT device.

In this process, the following timestamps may be considered:
t1: UE sends a signal to the A-IoT device
t2: Signal arrives at the A-IoT device
t3: A-IoT device sends the signal (induced transmission) to the UE
t4: UE receives the signal from the A-IoT device

The processing time (t3−t2) should be known to the UE 1804 or NW, so that the propagation time could be determined by ((t4−t1)−(t3−t2))/2. An A-IoT device may not know network (NW) timing, so the whole operation may be based on UE's own timing. For example, a UE 1804 may transmit at an UL symbol of a slot, if an A-IoT device, e.g., the A-IoT device 1806-1, could control the processing time (t3−t2) longer than a symbol duration, then the UE 1804 may not need another RF chain to receive when one RF chain is transmitting.

The UE 1804 could receive the induced transmission of the A-IoT device 1806-1 in the DL symbol of the slot. The transmission waveform of the A-IoT device 1806-1, or the triggered waveform from the UE 1804, may not be known to other UEs to avoid spoofing.

TDOA may require A-IoT devices 1806-1, 1806-2 . . . , 1806-n to be synced to the NW. However, some types of A-IoT devices 1806-1, 1806-2 . . . , 1806-n may not sync to the NW to learn subframe/slot boundary.

Position Calculation at gNB and UE: Both the gNB 1802 and the UE 1804 may use these measurements to calculate the UE's position. In such case, both the gNB 1802 and the UE 1804 may know the position of the A-IoT devices 1806-1, 1806-2 . . . , 1806-n, such as geolocations of the A-IoT device 1806-1.

In some embodiments, position calculation may be performed by a computation entity: a computation entity may use the measurements from both the gNB 1802 and the UE 1804 to calculate the UE's position. The computation entity may be the gNB 1802, the UE 1804, or another network element. In this scenario, this computation entity may know the geolocations of the A-IoT devices 1806-1, 1806-2 . . . , 1806-n.

In some embodiments, the position of the UE 1804 may be triangulated through multiple measurement results for the positioning parameter from the multiple A-IoT devices 1806-1, 1806-2 . . . , 1806-n. Positioning parameters may include TDOA, RTT, and RSSI, which are then used in the subsequent operations as follows:

TDOA: By comparing the time of arrival of the signals from different A-IoT devices 1806-1, 1806-2 . . . , 1806-n, both the gNB 1802 and the UE 1804 can estimate the relative distance between the UE 1804 and each A-IoT device. By doing this for multiple A-IoT devices 1806-1, 1806-2 . . . , 1806-n, they can triangulate the position of the UE 1804.

RTT: By measuring the Round-Trip Time (RTT) of the signals between the UE 1804 and each A-IoT device, a computation entity, such the UE 1804 itself, or the gNB 1802, can estimate the relative distance between the UE 1804 and each A-IoT device. This may require both the UE 1804 and each A-IoT device to transmit a reference signal for measurement. By doing this for multiple A-IoT devices 1806-1, 1806-2 . . . , 1806-n, the computation entity can triangulate the relative position of the UE 1804.

RSSI: By measuring the signal strength of the backscattered signals from different A-IoT devices 1806-1, 1806-2 . . . , 1806-n, both the gNB 1802 and the UE 1804 can estimate the distance between the UE 1804 and each A-IoT device. Again, by doing this for multiple A-IoT devices 1806-1, 1806-2 . . . , 1806-n, they can triangulate the position of the UE 1804.

Position Reporting: Once the gNB 1802 has calculated the position of the UE 1804, it can be used for various network operations. For instance, the gNB 1802 can use the UE's position to make handover decisions, optimize network performance, or provide location-based services. On the other hand, the UE 1804 can use its position for applications like navigation or location-based services.

This process may allow for both UE 1804 and the gNB 1802 to estimate the UE's position using passive A-IoT devices 1806-1, 1806-2 . . . , 1806-n and backscattering. It may leverage existing mechanisms like SRS transmission from the UE 1804, signal measurements at the gNB 1802 and the UE 1804, and unique IDs of A-IoT devices 1806-1, 1806-2 . . . , 1806-n. The accuracy of this method will depend on factors like the number and distribution of A-IoT devices 1806-1, 1806-2 . . . , 1806-n, the quality of the backscattered signals, and the precision of the A-IoT devices' known locations.

Passive A-IoT devices 1806-1, 1806-2 . . . , 1806-n may use a technique called backscattering to reflect the Sounding Reference Signal (SRS) transmitted by the UE 1804. The backscattering process may involve modulating the received SRS by changing the properties of the signal such as amplitude, phase, or frequency.

In some embodiment, once the position of the UE 1804 is calculated by a computation entity, such as the gNB 1802, it can be utilized for various network operations. For instance, the gNB 1802 can use the UE's position to make handover decisions, optimize network performance, or provide location-based services. On the other hand, the UE 1802 can use its position for applications like navigation or location-based services.

This process may allow for both the UE 1804 and the computation entity to estimate the UE's position using passive A-IoT devices 1806-1, 1806-2 . . . , 1806-n and backscattering. It may leverage existing mechanisms like the transmission of a general radio signal from the UE 1804, signal measurements at the computation entity and the UE 1804, and unique IDs of A-IoT devices 1806-1, 1806-2 . . . , 1806-n. The accuracy of this method will depend on factors like the number and distribution of A-IoT devices 1806-1, 1806-2 . . . , 1806-n, the quality of the backscattered signals, and the precision of the A-IoT devices' known locations.

Passive A-IoT devices 1806-1, 1806-2 . . . , 1806-n may use a technique called backscattering to reflect the general radio signal transmitted by the UE 1804. The backscattering process may involve modulating the received signal by changing the properties of the signal such as amplitude, phase, or even frequency. Changing the frequency is feasible and could result in the UE 1804 receiving a signal with a different root index due to frequency offset.

In another embodiment, passive A-IoT devices 1806-1, 1806-2 . . . , 1806-n may employ backscattering, altering the properties of the radio signal transmitted by the UE 1804. Notably, the frequency can be altered. This adjustment could lead to the UE 1804 receiving a signal with a different cyclic shift due to a frequency offset, reminiscent of the cyclic shift concept in NTN.

To add information (like a unique ID) to the reflected SRS, an A-IoT device such as the A-IoT device 1806-1, can use a modulation technique such as On-Off Keying (OOK). The following is how it works:

SRS Reception and OOK Modulation: When the A-IoT device 1806-1 receives the SRS from the UE 1804, it may modulate this signal using OOK. In this process, the presence of a signal for a specific duration represents a binary ‘1’, and the absence of a signal for the same duration represents a binary ‘0’. The A-IoT device 1806-1 may use this way to add its unique ID (represented in binary) to the reflected SRS.

For example, if the A-IoT device's unique ID is ‘101’, it may modulate the reflected SRS such that it transmits a signal for a specific duration (representing ‘1’), then no signal for the same duration (representing ‘0’), and then a signal again for the same duration (representing ‘1’).

In some embodiment, when the A-IoT device 1806-1 receives a general radio signal from the UE 1804, it may modulate this signal using OOK. In this process, the presence of a signal for a specific duration represents a binary ‘1’, and the absence of a signal for the same duration represents a binary ‘0’. The A-IoT device 1806-1 may use this way to add its unique ID (represented in binary) to the reflected signal.

The UE 1804 should know the configuration of the waveform from higher layer signaling for the signal configuration that the A-IoT device 1806-1 may transmit. The triggering by the UE 1804 and the response by the A-IoT device 1806-1 could be similar to aperiodic SRS triggering. The UE 1804 may read the Downlink Control Information (DCI) to know there is aperiodic SRS triggering. The time from the last symbol of Physical Downlink Control Channel (PDCCH) to when the UE 1804 knows the DCI content is the UE processing time. The SRS may not be sent within the processing time.

There could be an A-IoT device where the processing time is controllable. Another possibility is that the gNB 1802 sends the triggering signal to A-IoT devices 1806-1, 1806-2 . . . , 1806-n, and the A-IoT devices 1806-1, 1806-2 . . . , 1806-n respond with the induced transmission to the UE 1804. In this way, all the UEs may receive the signals at the same time. If each UE triggers the induced transmission of A-IoT devices 1806-1, 1806-2 . . . , 1806-n, there could be interference among UEs' triggering. Alternatively, it could be scheduled by the network for each UE's triggering transmission, similar to the network scheduling SRS transmission for each UE.

SRS Reflection: After modulating the received SRS with its unique ID using OOK, the A-IoT device 1806-1 may reflect the signal back towards the gNB 1802 and the UE 1804. The reflected signal now may carry the original SRS as well as the unique ID of the A-IoT device 1806-1.

By using backscattering and OOK, the A-IoT device 1806-1 can effectively reflect the SRS and add its unique ID to the reflected signal. The gNB 1802 and the UE 1804, upon receiving this reflected signal, can then identify the A-IoT device and use the signal for various purposes such as UE positioning.

FIG. 18(B) is a sequence diagram 1850 for the UE behavior, gNB behavior, and the signaling. As shown in FIG. 18(B), the UE 1804 may initiate the process by transmitting a radio signal, such as an SRS. An A-IoT device in an A-IoT device set including one or more A-IoT devices, such as the A-IoT device 1806-1, may intercept this signal, add its unique ID using OOK, and reflect the modulated SRS back to both the UE 1804 and the gNB 1802.

Then, both the UE 1804 and the gNB 1802 may receive the backscattered signals from the A-IoT device 1806-1, that is, a response signal that responds to the radio signal. The response signals received from all the A-IoT devices in the A-IoT device set form a response signal set. A response signal in the response signal set may be modulated by using OOK to include the ID of a corresponding A-IoT device, that is, the A-IoT device reflecting the response signal, such as the A-IoT device 1806-1.

Subsequently, both the UE 1804 and the gNB 1802 may measure position parameters like TDOA or RSSI, and identify the A-IoT device using the unique ID in the response signal.

Then, both the UE 1804 and the gNB 1802 may execute a positioning related operation based on the identified A-IoT device and the measurement for the positioning parameter. Executing the positioning related operation, for example, may include calculating the UE's position based on these measurements and the known geolocations of the A-IoT devices. The gNB 1802 may use the calculated position for various network operations, while the UE 1804 may use it for its own applications. In some embodiments, determining that the A-IoT device 1806-1 is near the UE 1804 may be based on successful reception by the UE 1804 of the D2R transmission from the A-IoT device 1806-1, which is in response to the R2D transmission.

### Multiple UE Finders

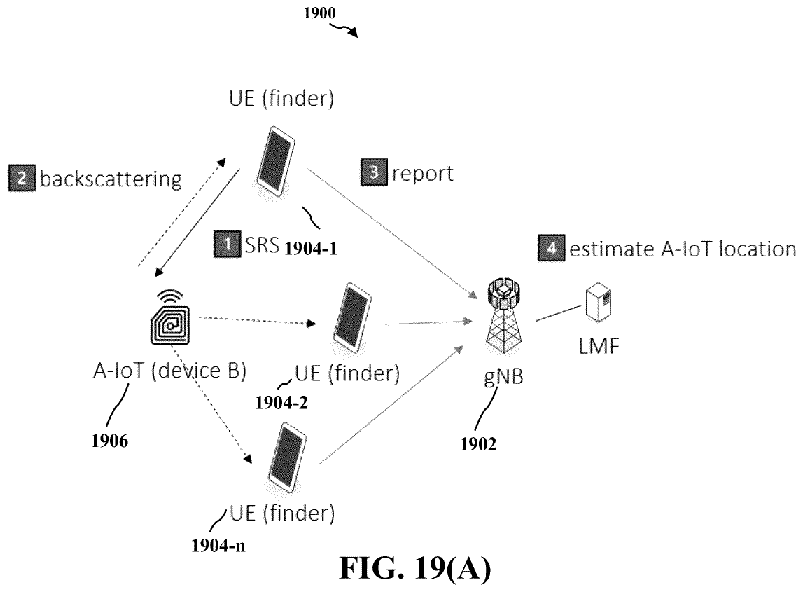

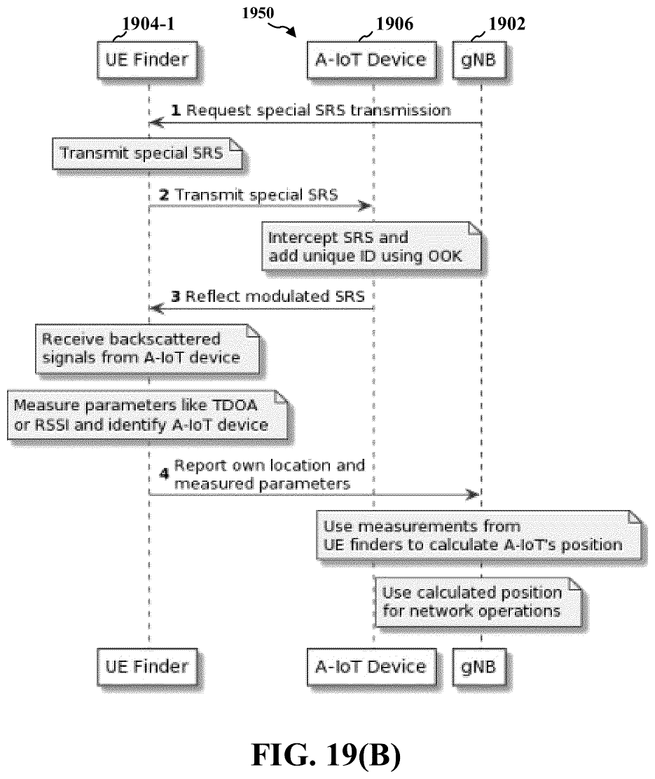

FIG. 19(A) is a diagram 1900 illustrating an example scheme utilized by a gNB for estimating the location of a passive A-IoT device with the assistance of multiple UEs. In this scenario, the UE that assists in estimating the location of a passive A-IoT device is called a UE finder, and the UE that pairs with the A-IoT device is called a UE owner.

gNB Request SRS Transmission: As shown in FIG. 19(A), the gNB 1902 may identify a need to locate a specific A-IoT device. It then may select one or multiple UE finders 1904-1, 1904-2 . . . , 1904-n and send them a request to transmit a special Sounding Reference Signal (SRS). For instance, the gNB 1902 may select UE finders 1904-1 and 1904-2 and send them a request to transmit a special SRS.

SRS Transmission from UE Finders: The selected UE finders 1904-1 and 1904-2 may transmit the special SRS as requested by the gNB 1902. The passive A-IoT device 1906 in the vicinity may intercept these signals.

Backscattering from A-IoT Device: Upon receiving the SRS, the A-IoT device 1906 may modulate it by adding its unique ID using On-Off Keying (OOK) and then reflect it back towards the UE finders. For instance, if the A-IoT device's unique ID is ‘101’, it may modulate the intercepted SRS and reflect it back towards the UE finders 1904-1 and 1904-2.

Signal Measurement at UE Finders: The UE finders 1904-1 and 1904-2 may receive the backscattered signals from the A-IoT device 1906. They may measure positioning parameters like Time Difference of Arrival (TDOA) or Received Signal Strength Indicator (RSSI) from these signals and identify the originating A-IoT device using the unique ID embedded in the signal. For example, UE finders 1904-1 and 1904-2 may measure the time it took for the backscattered signal to reach them (TDOA) and the strength of the received signal (RSSI). They may also extract the unique ID ‘101’ from the signal to identify the A-IoT device 1906.

Reporting Measurements to gNB: Each of the multiple UE finders 1904-1, 1904-2 . . . , 1904-n may report its own location, as well as the measured parameters (TDOA or RSSI), to the gNB 1902. For instance, UE finders 1904-1 and 1904-2 may report their own locations and the measured TDOA and RSSI values to the gNB 1902.

Position Calculation at gNB: The gNB 1902 may use these measurements from the UE finders 1904-1, 1904-2 . . . , 1904-n to determine the A-IoT device's position. In such case, the gNB 1902 may know the locations of the UE finders 1904-1, 1904-2 . . . , 1904-n. For example, the gNB 1902 may use the TDOA and RSSI values reported by UE finder 1904-1 and 1904-2, along with their known locations, to triangulate the position of the A-IoT device 1906.

Position Reporting: Once the gNB 1902 has calculated the position of the A-IoT device 1906, it can be used for various network operations. For instance, the gNB 1902 can use the calculated position to optimize network performance or provide location-based services.

FIG. 19(B) is a sequence diagram 1950 for the UE finder behavior, gNB behavior, and the signaling. As shown in FIG. 19(B), the gNB 1902 may initiate the process by requesting a special SRS transmission from the UE finder(s), such as the UE finder 1904-1. The UE finder 1904-1 may transmit a radio signal such as a special SRS, which is intercepted by the A-IoT device 1906. The A-IoT device 1906 may add its unique ID using OOK and reflect the modulated SRS back to the UE finder 1904-1. The UE finder 1904-1 may receive the backscattered signal, measure parameters like TDOA or RSSI, and identify the A-IoT device using the unique ID in the signal. The UE finder 1904-1 then may report its own location and the measured parameters to the gNB 1902. The gNB 1902 may use these measurements to calculate the A-IoT device's position and use the calculated position for various network operations.

In summary, in a first aspect, the disclosure provides a user equipment (UE), including: one or more non-transitory computer-readable media having computer-executable instructions embodied thereon, and at least one processor coupled to the one or more non-transitory computer-readable media and configured to execute the computer-executable instructions to: receive from a base station (gNB), a Sounding Reference Signal (SRS) and backscattered signals from multiple A-IoT devices, if the UE and the gNB know the geolocation of the A-IoT devices and can receive the backscattered signals from them; determine the unique ID of the A-IoT devices by modulating the received SRS and adding its unique ID to the signal, if the UE transmits an SRS and multiple nearby A-IoT devices intercept this signal; perform measurement of parameters like Time Difference of Arrival (TDOA) or Received Signal Strength Indicator (RSSI) from these signals and identify the originating A-IoT device using the unique ID embedded in the signal, if both the gNB and the UE receive the backscattered signals from multiple A-IoT devices; and transmit, to the gNB, the calculated position of the UE using these measurements and known geolocations of the A-IoT devices, if both the gNB and the UE use these measurements to calculate the UE's position.

In a second aspect, the disclosure provide a user equipment (UE), including: one or more non-transitory computer-readable media having computer-executable instructions embodied thereon, and at least one processor coupled to the one or more non-transitory computer-readable media and configured to execute the computer-executable instructions to: receive from a base station (gNB), a Sounding Reference Signal (SRS) and backscattered signals from multiple A-IoT devices, if the UE and the gNB know the geolocation of the A-IoT devices and can receive the backscattered signals from them; determine the unique ID of the A-IoT devices by using On-Off Keying (OOK) modulation technique to modulate the received SRS, if the A-IoT device receives the SRS from the UE; perform reflection of the modulated SRS back towards the gNB and the UE, if the A-IoT device modulates the received SRS with its unique ID using OOK; and transmit, to the gNB, the reflected signal which now carries the original SRS as well as the unique ID of the A-IoT device, if the A-IoT device reflects the signal back towards the gNB and the UE after modulating the received SRS with its unique ID using OOK.

In a third aspect, the disclosure provide a user equipment (UE), including: one or more non-transitory computer-readable media having computer-executable instructions embodied thereon, and at least one processor coupled to the one or more non-transitory computer-readable media and configured to execute the computer-executable instructions to: receive from a base station (BS), a Sounding Reference Signal (SRS) and backscattered signals from multiple A-IoT devices, if the UE and the BS both know the geolocation of the A-IoT devices and can receive the backscattered signals from them; determine the Time Difference of Arrival (TDOA) or Received Signal Strength Indicator (RSSI) from these signals and identify the originating A-IoT device using the unique ID embedded in the signal, if the UE and the BS both receive the backscattered signals from multiple A-IoT devices; perform position calculation using these measurements to estimate the UE's location, if both the gNB and the UE know the geolocations of the A-IoT devices; and transmit, to the BS, the calculated position of the UE, if the gNB has calculated the position of the UE and it can be used for various network operations.

In a fourth aspect, the disclosure provide a user equipment (UE), including: one or more non-transitory computer-readable media having computer-executable instructions embodied thereon, and at least one processor coupled to the one or more non-transitory computer-readable media and configured to execute the computer-executable instructions to: receive from a base station (BS), a request to transmit a special Sounding Reference Signal (SRS) and backscattered signals from a specific A-IoT device, if the gNB identifies a need to locate a specific A-IoT device and selects one or multiple UE finders; determine the Time Difference of Arrival (TDOA) or Received Signal Strength Indicator (RSSI) from these signals and identify the originating A-IoT device using the unique ID embedded in the signal, if the UE finders receive the backscattered signals from the A-IoT device; perform position calculation using these measurements to estimate the A-IoT device's location, if the gNB knows the locations of the UE finders; and transmit, to the BS, the calculated position of the A-IoT device, if the gNB has calculated the position of the A-IoT device and it can be used for various network operations.

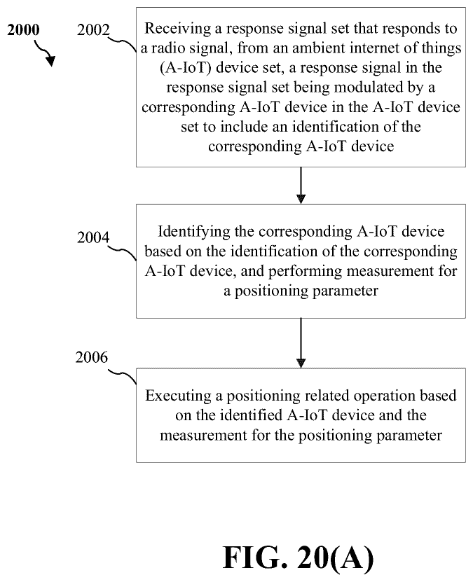

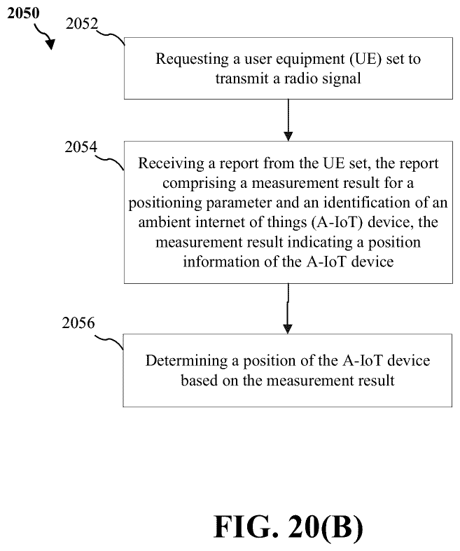

FIG. 20(A) is a flow chart 2000 of a process for positioning regarding the UE and the A-IoT device. This process involves interactions between a gNB (e.g., the gNB 1802), a UE (e.g., the UE 1804), and an ambient internet of things (A-IoT) device set (e.g., the A-IoT devices 1806-1, 1806-2 . . . , 1806-n).

At block 2002, a reader may receive a response signal set that responds to a radio signal, from an A-IoT device set such as the A-IoT devices 1806-1, 1806-2 . . . , 1806-n. The reader may be the UE 1804 or the gNB 1802. The radio signal may include a sounding reference signal (SRS). The radio signal may be transmitted by the reader itself, e.g., the UE 1804. Alternatively, the radio signal may be transmitted by another computation entity. For example, the reader is the UE 1804, and the another computation entity is the gNB 1802.

The response signal in the response signal set may be modulated by a corresponding A-IoT device, e.g., the A-IoT device 1806-1, in the A-IoT device set to include an identification of the corresponding A-IoT device 1806-1.

Then, at block 2004, the reader, e.g., the UE 1804, may identify the corresponding A-IoT device based on the identification of the corresponding A-IoT device, and perform measurement for a positioning parameter.

Finally, at block 2006, the UE 704 may execute a positioning related operation based on the identified A-IoT device and the measurement for the positioning parameter.

In some embodiments, executing the positioning related operation may include: determining, by the reader, a position of the reader based on the measurement. Alternatively, in some embodiments, executing the positioning related operation may include: determining that the corresponding A-IoT device is near the reader, based on successful reception by the reader of a device-to-reader (D2R) transmission from the corresponding A-IoT device, which is in response to a reader-to-device (R2D) transmission, wherein the D2R transmission represents a communication from the corresponding A-IoT device to the reader, while the R2D transmission represents a communication from the reader to the corresponding A-IoT device. In some embodiments, the position of the reader may be determined by the reader calculating its position. Alternatively, the position of the reader may also be determined by another computation entity calculating the position of the reader.

In some embodiments, the response signal set may include multiple response signals from multiple A-IoT devices 1806-1, 1806-2 . . . , and 1806-n in the A-IoT device set. The position of the UE 1804 may be triangulated through multiple measurement results for the positioning parameter from the multiple A-IoT devices 1806-1, 1806-2 . . . , and 1806-n.

The positioning parameter may include a time difference of arrival (TDOA) of the multiple response signals. The positioning parameter may also include a round-trip time (RTT) of a response signal in the response signal set, or a received signal strength indicator (RSSI) of the response signal in the response signal set.

In some embodiments, the identification of the corresponding A-IoT device, e.g., the A-IoT device 1806-1, may be incorporated into the response signal by the A-IoT device 1806-1 altering a property of the radio signal. In some embodiments, the alteration of the property of the radio signal may include: modulation of a carrier waveform within the radio signal using on-off keying (OOK).

In some embodiments, executing the positioning related operation may include: reporting a position information of the A-IoT device to another computation entity.

FIG. 20(B) is a flow chart 2050 of another process for positioning regarding the UE and the A-IoT device. This process involves interactions between a gNB (e.g., the gNB 1902), a UE set (e.g., the UEs 1904-1, 1904-2 . . . , 1904-n), and an ambient internet of things (A-IoT) device (e.g., the A-IoT device 1906).

At block 2052, the network, for example, through the gNB 1902, may request a user equipment (UE) set, e.g., including multiple UEs 1904-1, 1904-2 . . . , 1904-n, to transmit a radio signal.

Then, at block 2054, the gNB 1902 may receive a report from the UE set. The report may include a measurement result for a positioning parameter and an identification of an ambient internet of things (A-IoT) device, e.g., the A-IoT device 1906, the measurement result indicating a position information of the A-IoT device 1906.

Finally, at block 2056, the gNB 1902 may determine a position of the A-IoT device 1906 based on the measurement result.

In some embodiments, the position information of the A-IoT device may be obtained by a UE such as the UE 1904-1 in the UE set receiving a response signal that responds to the radio signal from the A-IoT device 1906. The response signal may be modulated by the A-IoT device 1906 to include the identification of the A-IoT device 1906.

In some embodiments, the method may further include reporting the position of the A-IoT device 1906 to a computation entity that pairs with the A-IoT device 1906.

In some embodiments, the network may include multiple base stations, and a base station receiving the report from the UE set may be different from a base station reporting the position of the A-IoT device 1906 to the computation entity.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a reader, comprising:
receiving a response signal set that responds to a radio signal, from an ambient internet of things (A-IoT) device set, a response signal in the response signal set being modulated by a corresponding A-IoT device in the A-IoT device set to include an identification of the corresponding A-IoT device;
identifying the corresponding A-IoT device based on the identification of the corresponding A-IoT device, and performing measurement for a positioning parameter; and
executing a positioning related operation based on the identified A-IoT device and the measurement for the positioning parameter.

2. The method of claim 1, wherein the reader comprises a user equipment (UE) or a gNodeB (gNB).

3. The method of claim 1, wherein the radio signal comprises a sounding reference signal (SRS).

4. The method of claim 1, wherein executing the positioning related operation comprises: determining, by the reader, a position of the reader based on the measurement; or
determining that the corresponding A-IoT device is near the reader, based on successful reception by the reader of a device-to-reader (D2R) transmission from the corresponding A-IoT device, which is in response to a reader-to-device (R2D) transmission, wherein the D2R transmission represents a communication from the corresponding A-IoT device to the reader, while the R2D transmission represents a communication from the reader to the corresponding A-IoT device.

5. The method of claim 4, wherein the position of the reader is determined by the reader calculating its position, or the position of the reader is determined by another computation entity calculating the position of the reader.

6. The method of claim 1, wherein the radio signal is transmitted by the reader, or the radio signal is transmitted by another computation entity.

7. The method of claim 1, wherein the response signal set comprises multiple response signals from multiple A-IoT devices in the A-IoT device set.

8. The method of claim 1, wherein a position of the reader is triangulated through multiple measurement results for the positioning parameter from the multiple A-IoT devices.

9. The method of claim 1, wherein the positioning parameter comprises a time difference of arrival (TDOA) of the multiple response signals.

10. The method of claim 1, wherein the positioning parameter comprises a round-trip time (RTT) of a response signal in the response signal set, or a received signal strength indicator (RSSI) of the response signal in the response signal set.

11. The method of claim 1, wherein the identification of the corresponding A-IoT device is incorporated into the response signal by the A-IoT device altering a property of the radio signal.

12. The method of claim 11, wherein the alteration of the property of the radio signal comprises: modulation of a carrier waveform within the radio signal using on-off keying (OOK).

13. The method of claim 1, wherein executing the positioning related operation comprises: reporting a position information of the A-IoT device to another computation entity.

14. A method of wireless communication of a network, comprising:
requesting a user equipment (UE) set to transmit a radio signal;
receiving a report from the UE set, the report comprising a measurement result for a positioning parameter and an identification of an ambient internet of things (A-IoT) device, the measurement result indicating a position information of the A-IoT device; and
determining a position of the A-IoT device based on the measurement result.

15. The method of claim 14, wherein the position information of the A-IoT device is obtained by a UE in the UE set receiving a response signal that responds to the radio signal from the A-IoT device, and the response signal is modulated by the A-IoT device to include the identification of the A-IoT device.

16. The method of claim 14, further comprising reporting the position of the A-IoT device to a computation entity that pairs with the A-IoT device.

17. The method of claim 16, wherein the network comprises multiple base stations, and a base station receiving the report from the UE set is different from a base station reporting the position of the A-IoT device to the computation entity.

18. An apparatus for wireless communication, the apparatus being a reader, comprising:
a memory; and
at least one processor coupled to the memory and configured to:
receive a response signal set that responds to a radio signal, from an ambient internet of things (A-IoT) device set, a response signal in the response signal set being modulated by a corresponding A-IoT device in the A-IoT device set to include an identification of the corresponding A-IoT device;
identify the corresponding A-IoT device based on the identification of the corresponding A-IoT device, and perform measurement for a positioning parameter; and
execute a positioning related operation based on the identified A-IoT device and the measurement for the positioning parameter.

19. The apparatus of claim 18, wherein the reader comprises a user equipment (UE) or a gNodeB (gNB).

20. The apparatus of claim 18, wherein the radio signal comprises a sounding reference signal (SRS).
